(19) United States
(12) Patent Application Publication
(10) Pub. No.: US 2022/0195147 A1
(43) Pub. Date: Jun. 23, 2022

(54) FLAME RETARDANT MIXTURE FOR THERMOPLASTIC POLYMERS

(71) Applicant: CLARIANT INTERNATIONAL LTD, Muttenz (CH)

(72) Inventors: Sebastian HOEROLD, Diedorf (DE); Eva Maria LEUSCHNER, Augsburg (DE); Elke SCHLOSSER, Augsburg (DE)

(73) Assignee: CLARIANT INTERNATIONAL LTD, Muttenz (CH)

(21) Appl. No.: 17/429,572

(22) PCT Filed: Feb. 6, 2020
(86) PCT No.: PCT/EP2020/052977

§ 371 Date: Aug. 9, 2021

(30) Foreign Application Priority Data
Feb. 11, 2019 (DE) 10 2019 201 727.4

(51) Int. Cl. C08K 13/02; C09K 21/12; C09K 21/02; C08K 13/04

(52) U.S. Cl. CPC C08K 13/02; C09K 21/12; C08K 5/5313; C08K 13/04; C09K 21/02

(57) ABSTRACT

The invention relates to a flame retardant mixture for thermoplastic polymers, comprising as component A) 30% to 55% by weight of a zinc salt of a di-alkylphosphinic acid of the formula (I) in which R¹ and R² are the same or different and are C₁-C₁₈-alkyl linear, branched or cyclic, C₆-C₁₈-aryl, C₇-C₁₈-arylalkyl and/or C₇-C₁₈-alkylaryl, and M is zinc and m=1 to 2, as component B) 45% to 70% by weight of one or more reaction products of melamine with polyphosphoric acids and/or condensed melamine with polyphosphoric acids, as component C) 0% to 10% of at least one further inorganic flame retardant which is zinc borate, zinc stannate, zinc phosphate, zinc pyrophosphate, magnesium borate and/or calcium stannate, as component D) 0% to 20% by weight of one or more condensation products of melamine, as component E) 0% to 2% by weight of at least one phosphite or phosphinite or mixtures thereof and as component F) 0% to 2% by weight of at least one ester and/or salt of long chain aliphatic carboxylic acids (fatty acids) typically having chain lengths of C₁₄ to C₄₀, where the sum total of the components is always 100% by weight.

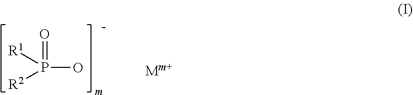

The present invention relates to a flame retardant mixture for thermoplastic polymers and to polymers comprising said flame retardant mixture.

Owing to their chemical composition, many plastics are readily combustible. In order to be able to attain the high flame retardancy demands made by plastics processors and in some cases by the legislator, plastics generally have to be modified with flame retardants. For this purpose, a multitude of different flame retardants and flame retardant synergists are known and also commercially available. Owing to their more advantageous secondary fire characteristics with regard to smoke gas density and small gas composition and for environmental reasons, nonhalogenated flame retardant systems have been used with preference for some time.

Among the nonhalogenated flame retardants, the salts of phosphinic acids (phosphinates) have been found to be very effective particularly for thermoplastic polymers (DE-A-2252258 and DE-A-2447727). Some derivatives of this class of flame retardant are valued owing to their minor adverse effect on the mechanical properties of the thermoplastic molding compounds and are used accordingly.

In addition, synergistic combinations of phosphinates with particular nitrogen-containing compounds, especially with melamine derivatives, have been found, and these have been found to be more effective as flame retardants in a whole series of polymers than the phosphinates alone (WO-A-2002/28953, WO-A-97/01664, and also DE-A-19734437 and DE-A-19737727).

In addition, it has been found that the flame retardancy of the various phosphinates in thermoplastic polymers can also be distinctly improved by addition of small amounts of organic or mineral compounds that do not contain any nitrogen, and that the additives mentioned can also improve the flame retardancy of phosphinates in combination with nitrogen-containing synergists (EP-A-0024167, WO-A-2004/016684). Particularly the combination of phosphinates with melamine polyphosphate leads to V-0 classifications in polyamides according to the UL 94 test.

When phosphinate-containing flame retardant systems are used, particularly at processing temperatures above 300° C., there was initially partial polymer degradation, discoloration of the polymer and evolution of smoke in the course of processing. However, it was possible to attenuate these difficulties by addition of basic or amphoteric oxides, hydroxides, carbonates, silicates, borates or stannates (WO-A-2004/022640).

For further improvement of thermal stability, WO-A-2012/045414 suggests the combination of a phosphinic salt with a salt of phosphorous acid. The flame retardancy of the phosphinic salts can be distinctly improved, especially in aliphatic polyamides. Compared to the use of melamine polyphosphate as synergist, no exudation after storage under moist and warm conditions is observed.

WO-A-2014/135256 describes flame-retardant polyamides comprising a phosphinic salt and a salt of phosphorous acid as synergists, and also reinforcers and further additives. The polyamide molding compounds thus obtained show good thermal stability and no tendency to migrate. The UL 94 V-0 fire class is attained, as is a creep resistance (comparative tracking index, CTI) of 600 volts.

Halogen-free polyamide compositions show frequently inadequate glow wire results with regard to the glow wire ignition temperature (GWIT) according to IEC 60335, meaning that there is a unwanted ignition of the polyamide at the glow wire tip at 750° C. A GWIT of 750° C. or higher is required for the use of flame-retardant polyamide molding compounds in domestic appliances that are left unattended.

US-A-2007/299171 describes thermoplastics, especially polyamides, comprising a phosphinic salt (F1), a reaction product of melamine and phosphoric acid (F2) and a condensation product of melamine (F3), where F1+F2 are at least 13%, preferably at least 15%, based on the overall composition. The simultaneous use of F1, F2 and F3 achieves a GWIT of 775° C. A disadvantage of such formulations is that the use of reaction products of melamine and phosphoric acid can result in migration effects. Moreover, thermal stability is limited to about 300° C.; there can be polymer degradation and breakdown at even higher processing temperatures, and also corrosion effects, for example on screws in compounding and injection molding.

WO-A-2009/109318A1 describes corrosion effects in the case of use of aluminum phosphinate in polyamides and polyesters. The addition of various additives can distinctly reduce corrosion.

US-A-2014/0371357 describes thermoplastic polyamides comprising 10-40% by weight of glass fibers, 10-40% by weight of melam and 0-15% by weight of a halogen-free flame retardant, where the polyamide contains up to 10 mol % of aromatic monomer units. A GWIT of at least 800° C. is attained; the halogen-free flame retardant may be a metal phosphinate. A disadvantage of the use of melam is the high filler level of 30-35% in order to attain UL 94 V-0 and GWIT>750° C., which reduces the flowability and mechanical properties of the polyamide compounds.

It was therefore an object of the present invention to provide halogen-free flame retardant mixtures for thermoplastic polymers, especially for polyam ides and polyesters, based on phosphorous- and nitrogen-containing flame retardant systems, which have high thermal stability and good mechanical properties, reliably attain both UL 94 V-0 up to specimen wall thickness 0.4 mm and the glow wire requirements of glow wire flammability index (GWFI) 960° C. and GWIT 775° C. for all wall thicknesses tested, have low corrosion, show minor migration effects and show good flowability and high electrical values (comparative tracking index (CTI)>550 V).

It has now been found that, surprisingly, the glow wire resistance of thermoplastic polyam ides and polyesters can be distinctly improved when the molding compound comprises a combination of a zinc phosphinate with a reaction product of melamine and condensed phosphoric acid in particular ratios. In the case of the specific combination, the balanced profile of properties of the polyam ides with regard to electrical and mechanical properties is substantially conserved. The molding compounds thus obtained surprisingly show only very low corrosion and little migration of the flame retardant used. The flame retardant mixture optionally further comprises further additives.

Thermoplastic polymers are processed predominantly in the melt. Barely any polymer withstands the associated changes in structure and state without any change in its chemical structure. Crosslinking, oxidation, changes in molecular weight and hence also changes in the physical and technical properties may be the result. In order to reduce stress on the polymers during processing, different additives are added according to the polymer.

Different additives are often used at the same time, each of which takes on a particular task. For instance, antioxidants and stabilizers are used in order that the polymer withstands processing without chemical damage and then has a sufficient period of stability with respect to outside influences such as heat, UV light, weathering and oxygen (air). In addition to improving flow characteristics, lubricants prevent excessive adhesion of the polymer melt to hot machine parts and act as a dispersant for pigments, fillers and reinforcers.

The use of flame retardants can influence the stability of polymers in the course of processing in the melt. Flame retardants frequently have to be added in high dosages in order to ensure sufficient flame retardancy of the plastic according to international standards. Due to their chemical reactivity, which is required for flame retardancy at high temperatures, flame retardants can impair the processing stability of polymers. This may result, for example, in increased polymer degradation, crosslinking reactions, outgassing or discoloration.

Polyamides are stabilized, for example, by small amounts of copper halides and aromatic amines, and sterically hindered phenols, with emphasis on the achievement of long-term stability at high sustained use temperatures (H. Zweifel (ed.): “Plastics Additives Handbook”, 5th Edition, Carl Hanser Verlag, Munich, 2000, pages 80 to 84).

The invention therefore provides a flame retardant mixture for thermoplastic polymers, comprising

as component A) 30% to 55% by weight of a zinc salt of a dialkylphosphinic acid of the formula (I)

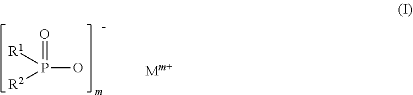

in which
R¹ and R² are the same or different and are Ci-Cis-alkyl linear, branched or cyclic, C₆-C₁₈-aryl, C₇-C₁₈-arylalkyl and/or C₇-C₁₈-alkylaryl, and M is zinc and m=1 to 2;

as component B) 45% to 70% by weight of one or more reaction products of melamine with polyphosphoric acids and/or condensed melamine with polyphosphoric acids,

as component C) 0% to 10% of one further inorganic flame retardant which is zinc borate, zinc stannate, zinc phosphate, zinc pyrophosphate, magnesium borate and/or calcium stannate,

as component D) 0% to 20% by weight of one or more condensation products of melamine,

as component E) 0% to 2% by weight of phosphite or phosphonite or mixtures thereof, and as component F) 0% to 2% by weight of an ester or salt of long-chain aliphatic carboxylic acids (fatty acids) which typically have chain lengths of C₁₄ to C₄₀, where the sum total of the components is always 100% by weight.

Preferably, the flame retardant mixture for thermoplastic polymers comprises

35% to 55% by weight of component A),

45% to 65% by weight of component B),

0% to 10% by weight of component C),

0% to 20% by weight of component D),

0% to 2% by weight of component E) and

0% to 2% by weight of component F).

More preferably, the flame retardant mixture for thermoplastic polymers comprises

38% to 45% by weight of component A),

45% to 60% by weight of component B),

2% to 10% by weight of component C),

0% to 20% by weight of component D),

0% to 2% by weight of component E) and

0% to 2% by weight of component F).

Especially preferably, the flame retardant mixture for thermoplastic polymers comprises

37% to 45% by weight of component A),

53% to 60% by weight of component B),

2% to 7% by weight of component C),

0% to 20% by weight of component D),

1% to 2% by weight of component E) and

0% to 2% by weight of component F).

Further preferably, the flame retardant mixture for thermoplastic polymers comprises

30% to 54.7% by weight of component A),

45% to 70% by weight of component B),

0.1% to 10% by weight of component C),

0% to 20% by weight of component D),

0.1% to 2% by weight of component E) and

0.1% to 2% by weight of component F).

Preferably, the flame retardant mixture for thermoplastic polymers alternatively comprises

30% to 54.6% by weight of component A),

45% to 70% by weight of component B),

0.1% to 10% by weight of component C),

0.1% to 20% by weight of component D),

0.1% to 2% by weight of component E) and

0.1% to 2% by weight of component F).

Preferably, in the flame retardant mixture for thermoplastic polymers, R¹ and R² in component A) are the same or different and are methyl, ethyl, n-propyl, isopropyl, n-butyl, tert-butyl, n-pentyl and/or phenyl.

Preferably, component D) is melam, melem and/or melon.

Preferably, component D) is melem.

Preferably, the flame retardant mixture for thermoplastic polymers as claimed in one or more of claims 1 to 9 further comprises telomers as component G) and wherein the telomers are ethylbutylphosphinic acid, dibutylphosphinic acid, ethylhexylphosphinic acid, butylhexylphosphinic acid, ethyloctylphosphinic acid, sec-butylethylphosphinic acid, 1-ethylbutyl butyl phosphinic acid, ethyl-1-methylpentylphosphinic acid, di-sec-butylphosphinic acid (di-1-methylpropylphosphinic acid), propylhexylphosphinic acid, dihexylphosphinic acid, hexylnonylphosphinic acid, dinonylphosphinic acid and/or zinc salts thereof; wherein components A) and G) are different.

The invention also relates to polymer compositions comprising a flame retardant mixture as claimed in at least one of claims 1 to 10 and as component H) thermoplastic and/or thermoset polymers.

Preferably, the thermoplastic polymer comprises polyam ides and/or polyesters.

Preferably, the flame retardant mixture is used for polyamides. The polyamide (PA) is preferably selected from the group consisting of PA 6, PA 6,6, PA 4,6, PA 12, PA 6,10, PA 4,10, Pa 10,10, PA 11, PA 6T/66, PA 6T/6, PA 4T, PA 9T, PA 10T, polyamide copolymers, polyamide blends and combinations thereof.

Particular preference is given to is nylon-6,6 or copolymers or polymer blends of nylon-6,6 and nylon-6.

Preferably, the flame retardant mixture is also used for polyesters. The polyesters are preferably polybutylene terephthalate (PBT) or polyethylene terephthalate (PET) or blends of PBT and PET or polyester elastomers.

Preferably, polymer compositions as claimed in one or more of claims 11 to 15 comprise

1% to 96% by weight of polymer

0% to 50% by weight of filler and/or reinforcer and

3% to 35% by weight of flame retardant mixture as claimed in at least one of claims 1 to 10, where the percentages are based on the total amount of the polymer composition.

Preferably, the polymer compositions comprise

15% to 75% by weight of polymer

15% to 45% by weight of filler and/or reinforcer and

10% to 25% by weight of flame retardant mixture as claimed in at least one of claims 1 to 10, where the percentages are based on the total amount of the polymer composition.

More preferably, the polymer compositions comprise

35% to 65% by weight of polymer

25% to 35% by weight of filler and/or reinforcer and

15% to 25% by weight of flame retardant mixture as claimed in at least one of claims 1 to 10, where the percentages are based on the total amount of the polymer composition.

Preferably, the polymer compositions as claimed in at least one of claims 11 to 18 have a comparative tracking index (CTI), measured by International Electrotechnical Commission Standard IEC-60112/3, of not less than 500 volts.

Preferably, the polymer compositions attain a V-0 assessment according to UL-94, especially measured on moldings of thickness 3.2 mm to 0.4 mm.

Preferably, the polymer compositions have a glow wire flammability index to IEC 60695-2-12 of not less than 960° C., especially measured on moldings of thickness 0.75-3 mm.

Preferably, the polymer compositions have a glow wire ignition temperature (GWIT) according to IEC-60695-2-13 of at least 775° C.

Preferably, the polymer compositions comprise further additives which are antioxidants, UV stabilizers, gamma-ray stabilizers, hydrolysis stabilizers, co-stabilizers for antioxidants, antistats, emulsifiers, nucleating agents, plasticizers, processing auxiliaries, impact modifiers, dyes, pigments, fillers, reinforcers and/or further flame retardants.

Preferably, the polymer compositions comprise glass fibers.

The invention also relates to the use of the aforementioned polymer compositions as molding compounds, semifinished products or finished products in the electrical, electronics and motor vehicle industries, in packaging in the food sector or in the games and toys sector, as label motifs, in medical technology or as plastic tags for individual labeling of animals.

The invention likewise relates to the use of the polymer compositions of the invention for production of parts of printed circuit boards, housings, foils, wires, switches, distributors, relays, resistors, capacitors, coils, lamps, diodes, LEDs, transistors, connectors, controllers, storage devices and sensors, in the form of large-area components, especially of housing parts for switchgear and in the form of components of complex shape with demanding geometry.

More preferably, the flame retardant mixture for thermoplastic polymers comprises zinc borate or zinc stannate as component C) and melam or melem as component D).

Preferably, the polyamides comprise 15% to 45% by weight of glass fibers.

Preferably, component A) is zinc diethylphosphinate.

Preferably, component B) is melamine polyphosphate or zinc melamine phosphates or calcium melamine phosphates.

Preferably, component C) is zinc borate.

Preference is given to using, as component E, phosphites of the formula (II)

P(OR₁)₃ (II)

in which R₁ is C₁-C₁₈-alkyl linear, branched or cyclic, C₆-C₁₈-aryl, C₇-C₁₈-arylalkyl and/or C₇-C₁₈-alkylaryl.

Preferably, the phosphonites (component E)) are components as described in H. Zweifel (Ed.): “Plastics Additives Handbook”, 5th Edition, Carl Hanser Verlag, Munich, 2000, pages 108 to 122, especially including those with the names Sandostab® P-EPQ, Irganoe 5057 and L118, Irgafos® 168, 12 and 38 and other compounds.

These often have the general structure

R—[P(OR⁵)₂]ₘ (III)

where
R is a mono- or polyvalent aliphatic, aromatic or heteroaromatic organic radical and

R⁵ is a compound of the structure (IV)

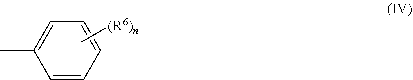

or the two R⁵ radicals form a bridging group of the structure (V)

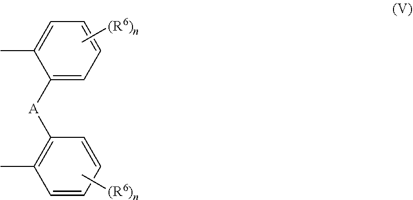

with
A a direct bond, O, S, C₁₋₁₈-alkylene (linear or branched), C₁₋₁₈-alkylidene (linear or branched), in which
R⁶ independently C₁₋₁₂-alkyl (linear or branched), C₁₋₁₂-alkoxy and/or C₅₋₁₂-cycloalkyl and

n 0 to 5 and

m 1 to 4.

Mixtures of phosphites with phosphonites may also be used.

Component F) preferably comprises alkali metal, alkaline earth metal, aluminum and/or zinc salts of long-chain fatty acids having 14 to 40 carbon atoms and/or reaction products of long-chain fatty acids having 14 to 40 carbon atoms with polyhydric alcohols such as ethylene glycol, glycerol, trimethylolpropane and/or pentaerythritol.

The invention additionally relates to the use of the flame retardant mixture of the invention in flame-retardant polyamide compositions in or for plug connectors, current-bearing components in power distributors (residual current protection), circuit boards, potting compounds, plug connectors, circuit breakers, lamp housings, LED housings, capacitor housings, coil element ventilators, grounding contacts, plugs, in/on printed circuit boards, housings for plugs, cables, flexible circuit boards, charging cables for mobile phones, motor covers, textile coatings and other products.

It has been found that, surprisingly, the use of the flame retardant mixture of the invention in polyamide compositions results in good flame retardancy (V-0, GWFI and especially GWIT) combined with improved flowability, low corrosion, high thermal stability and high impact resistance. Polymer degradation is prevented or very greatly reduced and no mold deposits or exudation are observed. The flame-retardant polyamide compositions of the invention additionally show only slight discoloration, if any, on processing in the melt.

According to Hans Domininghaus in “Die Kunststoffe and ihre Eigenschaften” [The Polymers and Their Properties], 5th edition (1998), page 14, thermoplastic polyamides are polyam ides wherein the molecular chains have no side branches or else varying numbers of side branches of greater or lesser length, and which soften when heated and are virtually infinitely shapable.

Preferably, the aliphatic polyam ides and copolyam ides are nylon-12, nylon-4, nylon-4,6, nylon-6, nylon-6,6, nylon-6,9, nylon-6,10, nylon-6,12, nylon-6,66, nylon-7,7, nylon-8,8, nylon-9,9, nylon-10,9, nylon-10,10, nylon-11, nylon-12, etc. These are known, for example, by the trade names Nylon®, from DuPont, Ultramid®, from BASF, Akulon®, from DSM, Zytel®, from DuPont; Durethan®, from Bayer and Grillamid®, from Ems Chemie.

Also suitable with preference are aromatic polyamides proceeding from m-xylene, diamine and adipic acid; polyamides prepared from hexamethylenediamine and iso- and/or terephthalic acid and optionally an elastomer as a modifier, for example poly-2,4,4-trimethylhexamethyleneterephthalamide or poly-m-phenyleneisophthalamide, block copolymers of the aforementioned polyam ides with polyolefins, olefin copolymers, ionomers or chemically bound or grafted elastomers, or with polyethers, for example with polyethylene glycol, polypropylene glycol or polytetramethylene glycol. In addition, EPDM- or ABS-modified polyam ides or copolyam ides; and polyam ides condensed during processing (“RIM polyimide systems”).

Preference is also given to blends of nylon-6,6 and one or more semiaromatic amorphous polyamides.

Other flame retardants or flame retardant synergists that are not mentioned specifically here may also be employed. It is especially possible to use nitrogen-containing flame retardant such as melamine cyanurate or further phosphorus flame retardant such as aryl phosphates or red phosphorus. In addition, it is also possible to use salts of aliphatic and aromatic sulfonic acids and mineral flame retardant additives such as aluminium hydroxide and/or magnesium hydroxide, calcium magnesium carbonate hydrates (e.g. DE-A-4236122). Also useful are flame retardant synergists from the group of the oxygen-, nitrogen- or sulfur-containing metal compounds, preferably zinc oxide, zinc hydroxystannate, zinc sulfide, molybdenum oxide, titanium dioxide, magnesium oxide, magnesium carbonate, calcium carbonate, calcium oxide, titanium nitride, boron nitride, magnesium nitride, zinc nitride, calcium phosphate, calcium borate, magnesium borate or mixtures thereof.

Further flame retardant additives that are suitable with preference are charcoal formers, more preferably polyalcohols such as pentaerythritol and dipentaerythritol, phenol-formaldehyde resins, polycarbonate, polyimides, polysulfones, polyethersulfones or polyetherketones, and anti-dripping agents, especially tetrafluoroethylene polymers.

The flame retardant is may be added in pure form, or else via masterbatches or compactates.

Preferably, the condensed melamine compounds (component C) are melam or melem.

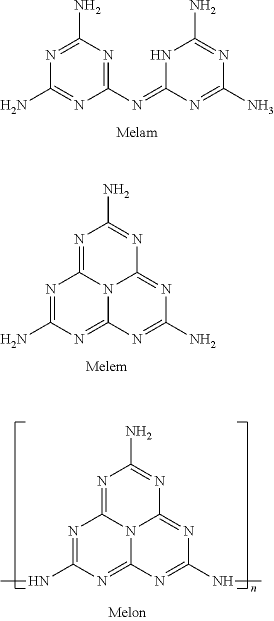

The flame-retardant polyamide compositions comprising the flame retardant mixture of the invention, in a further preferred embodiment, may comprise at least one filler or reinforcer.

It is also possible here to use mixtures of two or more different fillers and/or reinforcers, preferably based on talc, mica, silicate, quartz, titanium dioxide, wollastonite, kaolin, amorphous silicas, nanoscale minerals, more preferably montmorillonites or nanoboehmite, magnesium carbonate, chalk, feldspar, barium sulfate, glass beads and/or fibrous fillers and/or reinforcers based on carbon fibers and/or glass fibers. Preference is given to using mineral particulate fillers based on talc, mica, silicate, quartz, titanium dioxide, wollastonite, kaolin, amorphous silicas, magnesium carbonate, chalk, feldspar, barium sulfate and/or glass fibers.

Particular preference is given to using mineral particulate fillers based on talc, wollastonite, kaolin and/or glass fibers.

Particular preference is further also given to using acicular mineral fillers. Acicular mineral fillers are understood in accordance with the invention to mean a mineral filler having highly pronounced acicular character. Examples include acicular wollastonites. Preferably, the mineral has a length to diameter ratio of 2:1 to 35:1, more preferably of 3:1 to 19:1, especially preferably of 4:1 to 12:1. The average particle size of the acicular minerals usable in accordance with the invention is preferably less than 20 μm, more preferably less than 15 μm, especially preferably less than 10 μm, determined with a CILAS granulometer.

The filler and/or reinforcer may, in a preferred embodiment, have been surface-modified, preferably with an adhesion promoter or adhesion promoter system, more preferably a silane-based adhesion promoter system. However, the pretreatment is not absolutely necessary. Especially in the case of use of glass fibers, in addition to silanes, it is also possible to use polymer dispersions, film formers, branching agents and/or glass fiber processing auxiliaries.

The glass fibers for use with particular preference, which generally have a fiber diameter between 7 and 18 μm, preferably between 9 and 15 μm, are added in the form of continuous fibers or in the form of chopped or ground glass fibers. These fibers may have been modified with a suitable sizing system and an adhesion promoter or adhesion promoter system, preferably based on silane.

The flame-retardant polyamide compositions comprising the flame retardant mixture of the invention may also comprise further additives. Preferred additives in the context of the present invention are antioxidants, UV stabilizers, gammaray stabilizers, hydrolysis stabilizers, antistats, emulsifiers, nucleating agents, plasticizers, processing auxiliaries, impact modifiers, dyes and pigments. The additives may be used alone or in a mixture or in the form of masterbatches.

Suitable antioxidants are, for example, alkylated monophenols, e.g. 2,6-di-tert-butyl-4-methylphenol; alkylthiomethylphenols, e.g. 2,4-dioctylthiomethyl-6-tert-butylphenol; hydroquinones and alkylated hydroquinones, e.g. 2,6-di-tert-butyl-4-methoxyphenol; tocopherols, e.g. α-tocopherol, β-tocopherol, γ-tocopherol, δ-tocopherol and mixtures thereof (vitamin E); hydroxylated thiodiphenyl ethers, e.g. 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-di-methyl-4-hydroxyphenyl) disulfide; alkylidenebisphenols, e.g. 2,2′-methylenebis(6-tert-butyl-4-methylphenol);

O-, N- and S-benzyl compounds, e.g. 3,5,3′,5′-tetra-tert-butyl-4,4′-dihydroxydibenzyl ether; hydroxybenzylated malonates, e.g. dioctadecyl 2,2-bis(3,5-di-tert-butyl-2-hydroxybenzyl)malonate; hydroxybenzyl aromatics, e.g. 1,3,5-tris-(3,5-di-tert-butyl)-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris-(3,5-di-tert-butyl-4-hydroxybenzyl)phenol; triazine compounds, e.g. 2,4-bisoctylmercapto-6-(3,5-di-tert-butyl-4-hydroxyanilino)-1,3,5-triazine; benzyl phosphonates, e.g. dimethyl 2,5-di-tert-butyl-4-hydroxybenzylphosphonate; acylaminophenols, 4-hydroxylauramide, 4-hydroxystearanilide, N-(3,5-di-tert-butyl-4-hydroxyphenyl)carbamic acid octyl ester; esters of β-(3,5-di-tert-butyl-4-hydroxyphenyl)propionic acid with mono- or polyhydric alcohols; esters of β-(5-tert-butyl-4-hydroxy-3-methylphenyl)propionic acid with mono- or polyhydric alcohols; esters of β-(3,5-dicyclohexyl-4-hydroxyphenyl)propionic acid with mono- or polyhydric alcohols; esters of 3,5-di-tert-butyl-4-hydroxyphenylacetic acid with mono- or polyhydric alcohols; amides of β-(3,5-di-tert-butyl-4-hydroxyphenyl)propionic acid, for example N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

Particular preference is given to using sterically hindered phenols alone or in combination with phosphites, particular preference being given to the use of N,N′-bis[3-(3′,5′-di-tert-butyl-4′-hydroxyphenyl)propionyl]hexamethylenediamine (e.g. Irganox® 1098 from BASF SE, Ludwigshafen, Germany).

Suitable UV absorbers and light stabilizers are, for example, 2-(2′-hydroxyphenyl)benzotriazoles, for example 2-(2′-hydroxy-5′-methylphenyl)benzotriazole; 2-hydroxybenzophenones, for example the 4-hydroxy, 4-methoxy, 4-octoxy, 4-decyloxy, 4-dodecyloxy, 4-benzyloxy, 4,2′,4-trihydroxy, 2′-hydroxy-4,4′-dimethoxy derivative; esters of optionally substituted benzoic acids, for example 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate; acrylates, for example ethyl or isooctyl α-cyano-β,β-diphenylacrylate, methyl α-carbomethoxycinnamate, methyl or butyl α-cyano-β-methyl-p-methoxycinnamate, methyl α-carbomethoxy-p-methoxycinnamante, N-(β-carbomethoxy-β-cyanovinyl)-2-methylindoline.

Colorants used are preferably inorganic pigments, especially titanium dioxide, ultramarine blue, iron oxide, zinc sulfide or carbon black, and also organic pigments, preferably phthalocyanines, quinacridones, perylenes, and dyes, preferably nigrosin and anthraquinones.

Suitable polyamide stabilizers are, for example, copper salts in combination with iodides and/or phosphorus compounds and salts of divalent manganese.

Suitable basic costabilizers are melamine, polyvinylpyrrolidone, dicyandiamide, triallyl cyanurate, urea derivatives, hydrazine derivatives, amines, polyamides, polyurethanes, alkali metal and alkaline earth metal salts of higher fatty acids, for example calcium stearate, zinc stearate, magnesium behenate, magnesium stearate, sodium ricinoleate, potassium palmitate, antimony catecholate or tin catecholate.

Suitable nucleating agents are, for example, 4-tert-butylbenzoic acid, adipic acid and diphenylacetic acid, aluminum oxide or silicon dioxide, and most preferably talc, but this enumeration is non-conclusive.

Flow auxiliaries used are preferably copolymers of at least one a-olefin with at least one methacrylic acid or acrylic ester of an aliphatic alcohol. Particular preference is given to copolymers in which the a-olefin has been formed from ethene and/or propene and methacrylic acid or acrylic ester contains linear or branched alkyl groups having 6 to 20 carbon atoms as alcohol component. Very particular preference is given to (2-ethyl)hexyl acrylate.

Copolymers are suitable in accordance with the invention as flow auxiliaries are notable not only for their composition but also for their low molecular weight. Accordingly, suitable copolymers for the compositions that are to be conserved in accordance with the invention from thermal breakdown are particularly those that have melt flow index (MFI) measured at 190° C. and a load of 2.16 kg of at least 100 g/10 min, preferably of at least 150 g/10 min, more preferably of at least 300 g/10 min. The MFI serves for characterization of the flow of a melt of a thermoplastic and is subject to the standards ISO 1133 or ASTM D 1238. The MFI and all MFI figures in the context of the present invention relate or have been measured/determined uniformly according to ISO 1133 at 190° C. with a test weight of 2.16 kg.

Plasticizers for use with preference are dioctyl phthalate, dibenzyl phthalate, butyl benzyl phthalate, hydrocarbon oils or N-(n-butyl)benzenesulfonamide.

The present invention also relates to products, preferably fibers, films or moldings, obtainable from the compositions described in accordance with the invention by injection molding or extrusion.

Zinc phosphinates (component A)) are described in PCT/W097/39053, which is explicitly incorporated by reference. Particularly preferred phosphinates are zinc dimethylphosphinate, zinc diethylphosphinate, zinc ethylbutylphosphinate and zinc dibutylphosphinate.

Component F) preferably comprises aluminum stearate, calcium stearate, zinc stearate and/or calcium montanate.

Suitable components F) are esters or salts of long-chain aliphatic carboxylic acids (fatty acids) which typically have chain lengths of C₁₄ to C₄₀. The esters are reaction products of the carboxylic acids mentioned with standard polyhydric alcohols, for example ethylene glycol, glycerol, trimethylolpropane or pentaerythritol. Useful salts of the carboxylic acids mentioned are in particular alkali metal or alkaline earth metal salts or aluminum and zinc salts.

Preferred components F) are esters or salts of stearic acid, for example glyceryl monostearate or calcium stearate.

Component F) preferably also comprises reaction products of montan wax acids with ethylene glycol.

The reaction products are preferably a mixture of ethylene glycol mono-montan wax ester, ethylene glycol di-montan wax ester, montan wax acids and ethylene glycol.

Component F) also preferably comprises reaction products of montan wax acids with a calcium salt.

The reaction products are more preferably a mixture of 1,3-butanediol mono-montan wax ester, 1,3-butanediol di-montan wax ester, montan wax acids, 1,3-butanediol, calcium montanate and the calcium salt.

The polyamide compositions of the invention comprising the flame retardant mixture of the invention as claimed in one or more of claims 1 to 10 preferably have a glow wire ignition temperature (GWIT) according to IEC 60695-2-13 of 775° C. or more at a specimen thickness of 0.4-3 mm.

The aforementioned additives can be introduced into the polymer in a wide variety of different process steps. For instance, it is possible in the case of polyam ides, at the start or at the end of the polymerization/polycondensation or in a subsequent compounding operation, to mix the additives into the polymer melt. In addition, there are processing operations in which the additives are not added until a later stage. This is practiced especially in the case of use of pigment or additive masterbatches. There is also the possibility of applying additives, particularly in pulverulent form, to the polymer pellets, which may be warm as a result of the drying operation, by drum application.

The invention finally also relates to a process for producing flame-retardant polymer moldings, wherein inventive flame-retardant polymer molding compositions are processed by injection molding (for example injection molding machine of the Aarburg Allrounder type) and pressing, foam injection molding, internal gas pressure injection molding, blow molding, film casting, calendering, laminating or coating at elevated temperatures to give the flame-retardant polymer molding.

### EXAMPLES

1. Components Used

Commercial polyamides:

Nylon-6,6 (PA 6,6-GR): Ultramid® A27 (from BASF SE, Germany)

Nylon-6: Ultramie® B27 (from BASF SE, Germany)

Nylon-6T/6,6: Vestamid® HTplus M1000 (from Evonik, Germany)

Nylon-10T: Vestamid® HTplus M3000 (from Evonik, Germany)

PPG HP 3610 glass fibers with diameter 10 μm and length 4.5 mm (from PPG, the Netherlands)

Flame retardant (component A)):

zinc salt of diethylphosphinic acid, referred to hereinafter as DEPZN

By way of comparison:

aluminum salt of diethylphosphinic acid, referred to hereinafter as DEPAL

Flame retardant (component B)):

B1: melamine polyphosphate, Melapur® 200/70, from BASF AG, D, referred to as MPP

B2: zinc melamine phosphate, Safire® 400, from Huber, USA

Flame retardant (component C)):

C1: Firebrake® 500 zinc borate, from Rio Tinto, USA

C2: zinc stannate, Flamtare® S, from William Blythe, UK

Flame retardant (component D)):

Delflam® NFR (melem)

Phosphonites (component E)): Sandostab® P-EPQ, from Clariant GmbH, Germany

Wax components (component F)):

Licowae® E, from Clariant Produkte (Deutschland) GmbH, Germany (esters of montan wax acid)

2. Production, Processing and Testing of Flame-Retardant Polyamide Molding Compounds

The flame retardant components were mixed with the phosphonite, the lubricants and stabilizers in the ratio specified in the table and incorporated via the side intake of a twin-screw extruder (Leistritz ZSE 27/44D) into PA 6,6 at temperatures of 260 to 310° C., and into PA 6 at 250-275° C. The glass fibers were added via a second side intake. The homogenized polymer strand was drawn off, cooled in a water bath and then pelletized.

After sufficient drying, the molding compounds were processed to test specimens on an injection molding machine (Arburg 320 C Allrounder) at melt temperatures of 250 to 300° C., and tested and classified for flame retardancy using the UL 94 test (Underwriter Laboratories).

The UL 94 fire classifications are as follows:
V-0: afterflame time never longer than 10 sec, total of afterflame times for 10 flame applications not more than 50 sec, no flaming drops, no complete consumption of the specimen, afterglow time for specimens never longer than 30 sec after end of flame application.
V-1: afterflame time never longer than 30 sec after end of flame application, total of afterflame times for 10 flame applications not more than 250 sec, afterglow time for specimens never longer than 60 sec after end of flame application, other criteria as for V-0.
V-2: cotton indicator ignited by flaming drops, other criteria as for V-1.

not classifiable (ncl): does not comply with fire classification V-2.

Glow wire resistance was determined using the GWFI (glow wire flammability index) glow wire test according to IEC 60695-2-12 and the glow wire ignitability test GWIT (glow wire ignition temperature) according to IEC 60695-2-13. In the GWFI test, using three test specimens (for example using plates of geometry 60×60×1.5 mm), with the aid of a glow wire, at temperatures between 550 and 960° C., the maximum temperature at which an afterflame time of 30 seconds is not exceeded and the sample does not give off burning drops is determined. In the GWIT test, in a comparable measurement procedure, the glow wire ignition temperature 25 K higher (30 K between 900° C. and 960° C.) than the maximum glow wire temperature that does not lead to ignition in 3 successive tests even during the contact time of the glow wire is reported. Ignition is regarded here as a flame having a burning time of 5 seconds or more.

The flowability of the molding compositions was determined by finding the melt volume flow rate (MVR) at 275° C/2.16 kg. Higher MVR values mean better flowability in the injection molding process. However, a significant rise in the MVR value can also suggest polymer degradation.

Corrosion was studied with the aid of the plaque method.

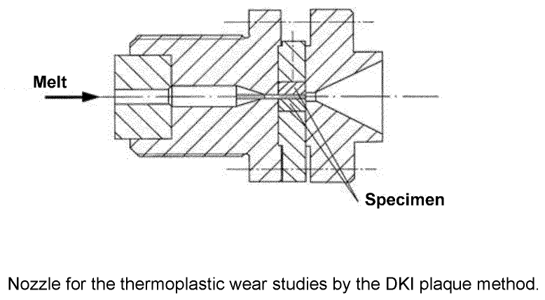

The plaque method, developed at the DKI (German Plastics Institute, Darmstadt), provides for model studies for comparative assessment of metallic materials or the corrosion and wear intensity of plastifying molding compounds. In this test, two specimens are arranged in pairs in the nozzle such that they form a rectangular gap of length 12 mm, width 10 mm and height adjustable from 0.1 to a maximum of 1 mm for the passage of the plastic melt (FIG. 1). Plastic melt is extruded (or injection-molded) through this gap from a plastifying unit with occurrence of high local shear stresses and shear rates in the gap.

A wear measurement parameter is the loss of weight of the test specimens determined by difference weighing of the test specimens with an analytical A&D Electronic Balance with a difference of 0.1 mg. The mass of the test specimens was determined before and after the corrosion test, in each case with polymer throughput 25 or 50 kg.

After a predefined throughput (generally 25 or 50 kg), the sample plaques are deinstalled and adhering plastic is cleaned off by physical/chemical means. Physical cleaning is effected by removal of the hot plastic mass by rubbing with a soft material (cotton). Chemical cleaning is effected by heating the test specimens to 60° C. in m-cresol for 20 minutes. Plastic mass still adhering after the boiling is removed by rubbing with a soft cotton pad.

All tests in the respective series, unless stated otherwise, were performed under identical conditions (temperature programs, screw geometry, injection molding parameters, etc.) for comparability.

The results in which the flame retardant-stabilizer mixture according to the invention was used are listed in examples I1-I3. All amounts are reported as % by weight and are based on the polymer molding compound including the flame retardants, additives and reinforcers.

TABLE 1
PA 66 GF 30 test results. C1-C4 are comparative examples, I1 to I3 inventive
flame retardant mixtures in the polyamide molding compound

| | | C1 | C2 | C3 | C4 | I1 | I2 | I3 |
|---|---|---|---|---|---|---|---|---|
| Nylon-6,6 | [% by wt.] | 49.55 | 49.55 | 49.55 | 49.55 | 49.55 | 49.55 | 47.55 |
| HP3610 glass fibers | [% by wt.] | 30 | 30 | 30 | 30 | 30 | 30 | 30 |
| A: DEPZN | [% by wt.] | | | | 13 | 8 | 9 | 10 |
| DEPAL | [% by wt.] | 13 | 8 | 9 | | | | |
| B1: MPP | [% by wt.] | 6 | 11 | 9 | 6 | 11 | 9 | 11 |
| C1: zinc borate | [% by wt.] | 1 | 1 | 2 | 1 | 1 | 2 | 1 |
| G: Licowax E | [% by wt.] | 0.25 | 0.25 | 0.25 | 0.25 | 0.25 | 0.25 | 0.25 |
| F: P-EPQ | [% by wt.] | 0.20 | 0.20 | 0.20 | 0.20 | 0.20 | 0.20 | 0.20 |

Test results

| UL 94 at thickness 0.4 mm | | V-0 | V-0 | V-0 | V-1 | V-0 | V-0 | V-0 |
|---|---|---|---|---|---|---|---|---|
| GWFI at thickness 0.4 mm | [° C.] | 960 | 960 | 960 | 960 | 960 | 960 | 960 |
| MVR 275° C./2.16 kg | | 4 | 5 | 5 | 15 | 10 | 12 | 12 |
| GWIT at thickness 0.75 mm | [° C.] | 725 | 800 | 775 | 700 | 800 | 750 | 800 |
| Corrosion [weight loss**] | [%] | 0.4 | 1 | 0.4 | 0.1 | 0.1 | <0.1 | 0.2 |
| Exudation* | | moderate | high | moderate | moderate | moderate | moderate | moderate |
| CTI | [volts] | 600 | 550 | 600 | 600 | 600 | 600 | 600 |
| Impact resistance | [kJ/m²] | 60 | 63 | 58 | 69 | 68 | 71 | 70 |
| Notched impact resistance | [kJ/m²] | 10 | 10 | 11 | 15 | 14 | 14 | 13 |

*14 days 100% humidity 70° C.
**of the metal plaques, weight before test 6 g

Only the inventive combination of zinc phosphinate, melamine polyphosphates and zinc borate gives polyamide molding compounds that attain the UL 94 V-0 fire class at 0.4 mm and at the same time have a GWIT greater than 775° C. and CTI 600 volts, low corrosion, modern exudation and impact resistance greater than 65 kJ/m², a notched impact resistance greater than 10 kJ/m².

By contrast, the combination of aluminum phosphinate with melamine polyphosphate and zinc borate shows distinct corrosion and significant exudation, and lower impact and notched impact resistance.

Furthermore, the polyamides with the combination of the invention do not show any mold deposits in injection molding, whereas mold deposits take place with the comparative examples even after 200 shots, which necessitates cleaning of the mold.

TABLE 2
PA 66 GF 30 test results. I4 to I10 inventive flame retardant mixtures in the polyamide molding compound

| | | I4 | I5 | I6 | I7 | I8 | I9 | I10 |
|---|---|---|---|---|---|---|---|---|
| Nylon-6,6 | [% by wt.] | 49.55 | 49.55 | 49.55 | 49.55 | 39.55 | 39.55 | 49.55 |
| Nylon-6T/66 | [% by wt.] | | | | | 10 | | |
| Nylon-6 | [% by wt.] | | | | | | 10 | |
| HP3610 glass fibers | [% by wt.] | 30 | 30 | 30 | 30 | 30 | 30 | 30 |
| A: DEPZN | [% by wt.] | 8 | 8 | 8 | 8 | 8 | 8 | 9.5 |
| B1: MPP | [% by wt.] | | 11 | 8 | 6 | 11 | 11 | 9.5 |
| B2: Satire 400 | [% by wt.] | 11 | | | | | | |
| D: melem | [% by wt.] | | | 3 | 5 | | | |
| C1: zinc borate | [% by wt.] | 1 | | 1 | 1 | 1 | 1 | |
| C2: zinc stannate | [% by wt.] | | 1 | | | | | 1 |
| G: Licowax E | [% by wt.] | 0.25 | 0.25 | 0.25 | 0.25 | 0.25 | 0.25 | 0.25 |
| F: P-EPQ | [% by wt.] | 0.20 | 0.20 | 0.20 | 0.20 | 0.20 | 0.20 | 0.20 |

Test results

| UL 94 at thickness 0.4 mm | | V-1 | V-0 | V-1 | V-1 | V-0 | V-0 | V-0 |
|---|---|---|---|---|---|---|---|---|
| GWFI at thickness 0.4 mm | [° C.] | 960 | 960 | 960 | 960 | 960 | 960 | 960 |
| MVR 275° C./2.16 kg | | 14 | 13 | 15 | 12 | 10 | 17 | 12 |
| GWIT at thickness 0.75 mm | [° C.] | 775 | 800 | 775 | 775 | 825 | 825 | 800 |
| Corrosion | [%] | 0.3 | <0.1 | 0.1 | <0.1 | 0.1 | 0.1 | 0.1 |
| Exudation* | | moderate | low | moderate | low | low | moderate | moderate |
| CTI | [volts] | 600 | 550 | 600 | 600 | 600 | 600 | 600 |
| Impact resistance | [kJ/m²] | 63 | 68 | 67 | 69 | 68 | 69 | 70 |
| Notched impact resistance | [kJ/m²] | 10 | 12 | 13 | 15 | 12 | 14 | 12 |

*14 days 100% humidity 70° C.

Overall, only the combinations of the invention attain all the parameters to be fulfilled.

TABLE 3
PA 6 GF 30 test results. C5-C7 are comparative examples, I11 to I14
inventive flame retardant mixtures in the polyamide molding compound

| | | C5 | C6 | C7 | I11 | I12 | I13 | I14 |
|---|---|---|---|---|---|---|---|---|
| Nylon-6 | [% by wt.] | 49.55 | 49.55 | 49.55 | 48.55 | 49.55 | 49.55 | 45.55 |
| HP3610 glass fibers | [% by wt.] | 30 | 30 | 30 | 30 | 30 | 30 | 30 |
| A: DEPZN | [% by wt.] | | | 13 | 10 | 8 | 9 | 11.5 |
| DEPAL | [% by wt.] | 13 | 8 | | | | | |
| B1: MPP | [% by wt.] | 6 | 11 | 6 | 10 | 11 | 9 | 11.5 |
| C1: zinc borate | [% by wt.] | 1 | 1 | 1 | 1 | 1 | 2 | 1 |
| G: Licowax E | [% by wt.] | 0.25 | 0.25 | 0.25 | 0.25 | 0.25 | 0.25 | 0.25 |
| F: P-EPQ | [% by wt.] | 0.20 | 0.20 | 0.20 | 0.20 | 0.20 | 0.20 | 0.20 |

Test results

| UL 94 at thickness 0.4 mm | | V-0 | V-1 | V-1 | V-0 | V-1 | V-0 | V-0 |
|---|---|---|---|---|---|---|---|---|
| GWFI at thickness 0.4 mm | [° C.] | 960 | 960 | 960 | 960 | 960 | 960 | 960 |
| MVR 250° C./2.16 kg | | 5 | 5 | 13 | 12 | 10 | 11 | 13 |
| GWIT at thickness 0.75 mm | [° C.] | 700 | 800 | 775 | 800 | 825 | 775 | 825 |
| Corrosion [weight loss**] | [%] | 0.3 | 0.8 | 0.4 | 0.1 | 0.1 | <0.1 | 0.1 |
| Exudation* | | moderate | high | moderate | moderate | moderate | moderate | moderate |
| CTI | [volts] | 600 | 550 | 600 | 600 | 600 | 600 | 600 |
| Impact resistance | [kJ/m²] | 62 | 64 | 59 | 69 | 68 | 71 | 70 |
| Notched impact resistance | [kJ/m²] | 11 | 11 | 12 | 15 | 14 | 15 | 14 |

*14 days 100% humidity 70° C.
**of the metal plaques, weight before test 6 g

In nylon-6 with glass fibers too, only the combinations of the invention attain all the parameters to be fulfilled. No mold deposits are observed here either in injection molding for the formulations of the invention.

1. A flame retardant mixture for thermoplastic polymers, comprising as component A) 30% to 55% by weight of a zinc salt of a dialkylphosphinic acid of the formula (I) 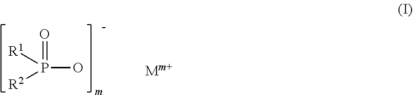
in which
R¹ and R² are the same or different and are C₁-C₁₈-alkyl linear, branched or cyclic, C₆-C₁₈-aryl, C₇-C₁₈-arylalkyl and/or C₇-C₁₈-alkylaryl, and M is zinc and m=1 to 2,
as component B) 45% to 70% by weight of one or more reaction products of melamine with polyphosphoric acids and/or condensed melamine with polyphosphoric acids,
as component C) 0% to 10% of at least one further inorganic flame retardant which is zinc borate, zinc stannate, zinc phosphate, zinc pyrophosphate, magnesium borate and/or calcium stannate,
as component D) 0% to 20% by weight of one or more condensation products of melamine,
as component E) 0% to 2% by weight of at least one phosphite or phosphinite or mixtures thereof and
as component F) 0% to 2% by weight of at least one ester and/or salt of long chain aliphatic carboxylic acids (fatty acids) typically having chain lengths of C₁₄ to C₄₀, where the sum total of the components is always 100% by weight.

2. The flame retardant mixture as claimed in claim 1, comprising
35% to 55% by weight of component A),
45% to 65% by weight of component B),
0% to 10% by weight of component C),
0% to 20% by weight of component D),
0% to 2% by weight of component E) and
0% to 2% by weight of component F).

3. The flame retardant mixture as claimed in claim 1, comprising
38% to 45% by weight of component A),
45% to 60% by weight of component B),
2% to 10% by weight of component C),
0% to 20% by weight of component D),
0% to 2% by weight of component E) and
0% to 2% by weight of component F).

4. The flame retardant mixture as claimed in claim 1, comprising
37% to 45% by weight of component A),
53% to 60% by weight of component B),
2% to 7% by weight of component C),
0% to 20% by weight of component D),
1% to 2% by weight of component E) and
0% to 2% by weight of component F).

5. The flame retardant mixture as claimed in claim 1, comprising
30% to 54.7% by weight of component A),
45% to 70% by weight of component B),
0.1% to 10% by weight of component C),
0% to 20% by weight of component D),
0.1% to 2% by weight of component E) and
0.1% to 2% by weight of component F).

6. The flame retardant mixture as claimed in claim 1, comprising
30% to 54.6% by weight of component A),
45% to 70% by weight of component B),
0.1% to 10% by weight of component C),
0.1% to 20% by weight of component D),
0.1% to 2% by weight of component E) and
0.1% to 2% by weight of component F).

7. The flame retardant mixture as claimed in claim 1, wherein R¹ and R² in component A) are the same or different and are methyl, ethyl, n-propyl, isopropyl, n-butyl, tert-butyl, n-pentyl and/or phenyl.

8. The flame retardant mixture as claimed in claim 1, wherein component D) is melam, melem and/or melon.

9. The flame retardant mixture as claimed in claim 1, wherein component D) is melem.

10. The flame retardant mixture as claimed claim 1, which further comprises telomers as component G) and wherein the telomers are ethylbutylphosphinic acid, dibutylphosphinic acid, ethylhexylphosphinic acid, butylhexylphosphinic acid, ethyloctylphosphinic acid, sec-butylethylphosphinic acid, 1-ethylbutyl butyl phosphinic acid, ethyl-1-methylpentylphosphinic acid, di-sec-butylphosphinic acid (di-1-methylpropylphosphinic acid), propylhexylphosphinic acid, dihexylphosphinic acid, hexylnonylphosphinic acid, dinonylphosphinic acid and/or zinc salts thereof; wherein components A) and G) are different.

11. A polymer composition comprising a flame retardant mixture as claimed in claim 1 and as component H) thermoplastic and/or thermoset polymers.

12. The polymer composition as claimed in claim 11, wherein the thermoplastic polymer comprises polyam ides and/or polyesters.

13. The polymer composition as claimed in claim 12, wherein the polyamide (PA) is selected from the group consisting of PA 6, PA 6,6, PA 4,6, PA 12, PA 6,10, PA 6T/66, PA 6T/6, PA 4T, PA 9T, PA 10T, polyamide copolymers, polyamide blends and combinations thereof.

14. The polymer composition as claimed in claim 12, wherein polyamide is nylon-6,6 or copolymers or polymer blends of nylon-6,6 and nylon-6.

15. The polymer composition as claimed in claim 12, wherein the polyesters are polybutylene terephthalate (PBT) or polyethylene terephthalate (PET) or blends of PBT and PET or polyester elastomers.

16. The polymer composition as claimed in claim 11, which comprises:
1% to 96% by weight of polymer;
0% to 50% by weight of filler and/or reinforcer; and
3% to 35% by weight of the flame retardant mixture, where the percentages are based on the total amount of the polymer composition.

17. The polymer composition as claimed in claim 16, which comprises:
15% to 75% by weight of polymer;
15% to 45% by weight of filler and/or reinforcer; and
10% to 25% by weight of the flame retardant mixture, where the percentages are based on the total amount of the polymer composition.

18. The polymer composition as claimed in claim 17, which comprises:
35% to 65% by weight of polymer;
25% to 35% by weight of filler and/or reinforcer; and
15% to 25% by weight of the flame retardant mixture, where the percentages are based on the total amount of the polymer composition.

19. The polymer composition as claimed in claim 11, which has a comparative tracking index, measured by International Electrotechnical Commission Standard IEC-60112/3, of not less than 500 volts.

20. The polymer composition as claimed in claim 11, which attains a V-0 assessment according to UL-94, especially measured on moldings of thickness 3.2 mm to 0.4 mm.

21. The polymer composition as claimed in claim 11, which has a glow wire flammability index to IEC 60695-2-12 of not less than 960° C., especially measured on moldings of thickness 0.75-3 mm.

22. The polymer composition as claimed in claim 11, which has a glow wire ignition temperature (GWIT) according to IEC-60695-2-13 of at least 775° C.

23. The polymer composition as claimed in claim 11, which comprises further additives as component H which are antioxidants, UV stabilizers, gamma-ray stabilizers, hydrolysis stabilizers, co-stabilizers for antioxidants, antistats, emulsifiers, nucleating agents, plasticizers, processing auxiliaries, impact modifiers, dyes, pigments, fillers, reinforcers and/or further flame retardants.

24. The polymer composition as claimed in claim 11, which comprises glass fibers.

25. The use of the polymer composition as claimed in claim 11 as molding compounds, semifinished products or finished products in the electrical, electronics and motor vehicle industries, in packaging in the food sector or in the games and toys sector, as label motifs, in medical technology or as plastic tags for individual labeling of animals.

26. The use of the polymer composition as claimed in claim 11 for production of parts of printed circuit boards, housings, foils, wires, switches, distributors, relays, resistors, capacitors, coils, lamps, diodes, LEDs, transistors, connectors, controllers, storage devices and sensors, in the form of large-area components, especially of housing parts for switchgear and in the form of components of complex shape with demanding geometry.
